(19) United States
(12) Patent Application Publication
(10) Pub. No.: US 2023/0420847 A1
(43) Pub. Date: Dec. 28, 2023

(54) DIPOLE ANTENNA, DUAL POLARIZE ANTENNA, AND ARRAY ANTENNA

(71) Applicant: DKK Company, Limited, Chiyoda-ku, Tokyo (JP)

(72) Inventors: Keisuke SATO, Chiyoda-ku, Tokyo (JP); Eiji AMAKAWA, Chiyoda-ku, Tokyo (JP)

(73) Assignee: DKK Company, Limited, Chiyoda-ku, Tokyo (JP)

(21) Appl. No.: 18/036,039

(22) PCT Filed: Nov. 4, 2021
(86) PCT No.: PCT/JP2021/040665

§ 371 Date: May 9, 2023

(30) Foreign Application Priority Data
Nov. 10, 2020 (JP) 2020-187014

(51) Int. Cl. H01Q 5/48; H01Q 9/06

(52) U.S. Cl. CPC H01Q 5/48; H01Q 9/065

(57) ABSTRACT

To provide a dipole antenna, a polarization shared antenna, and an array antenna that are suitable for a configuration of a multilayer substrate or another three-dimensional circuit in a band at 28 GHz or higher and in a high-frequency band corresponding thereto. This dipole antenna, polarization shared antenna, and array antenna have antenna parts provided to a dielectric layer, and comprise a pseudo-coaxial line that is formed on the dielectric layer and that is connected to the antenna parts, the pseudo coaxial line having an outer conductor and a signal line.

### TECHNICAL FIELD

The present invention relates to dipole antennas, polarized wave antennas, and array antennas suitable for mobile communication base station antennas. It also relates to dipole antennas, dual polarized dipole antennas, and array antennas.

### BACKGROUND ART

In mobile radio communications, application to MIMO (Multi Input Multi Output) is essential for capacity expansion. There is polarized wave MIMO that uses orthogonal dual polarization to realize MIMO.

In sake of the application to MIMO, mobile phone base station antennas use dual-polarized antennas. The dual-polarized antenna enables a single polarized antenna to radiate two orthogonally polarized waves, contributing to the miniaturization of base station antennas.

In the conventionally allocated SUB6 band, that is, a frequency band of 6 GHz or less, for example, a dipole antenna as described in Patent Literature 2 and a patch antenna as described in Patent Literature 1 are known.

On the other hand, since it is difficult to use dipole antennas in the 28 GHz band allocated for 5G and higher millimeter wave bands, patch antennas are being considered.

### PRIOR ART

### Patent Literature

Patent Literature 1 Japanese Patent Laid-Open No. 2003-46326
Patent Literature 2 Japanese Patent Laid-Open No. 2014-39192
Patent Literature 3 Japanese Patent No. 6341293
Patent Literature 4 Japanese Patent No. 5638827

### SUMMARY OF THE INVENTION

### Problems to be Solved by the Invention

A dipole antenna must include a balun circuit for operation.

Conventional balun circuits, for example, are implemented using a dielectric substrate, and the configuration is based on the premise that the substrate is self-supporting.

In other words, in the SUB6 band, each polarization antenna balun can be configured on a separate substrate and have a self-supporting structure.

However, in the 28 GHz band, the wavelength is very short and the antenna structure is small and fine, so it is impossible for the substrate to stand alone, and it is difficult to secure a self-supporting structure similar to SUB6.

Also, it is difficult to realize a dipole antenna as described in Patent Literature 2 in a configuration of a multilayer substrate. In three-dimensional circuits such as multi-layer boards, conductors are formed by through-holes in the vertical direction (the direction in which the balun circuit is formed), it is impossible to configure a through hole with a plane plate (strip line structure) as the conventional configuration example.

A patch antenna can be realized due to the ease of designing because it is usually configured as three-dimensional structure using a multi-layer substrate. In the case of a patch antenna as described in Patent Literature 1, it is possible to use dual-polarized waves by using a three-dimensional circuit such as a multilayer substrate, but the patch antenna are inferior to a dipole antenna in cross-polarization characteristics and isolation characteristics.

Even dipole antennas used in combination with patch antennas in cooperation with patch antennas, such as those described in Patent Literatures 3 and 4, are inferior to dipole antennas in cross-polarization characteristics and isolation characteristics. In addition, although the antenna described in Patent Literature 3 considers unnecessary radiation from the high-frequency element, neither Patent Literature 3 nor Patent Literature 4 considers the influence of the signal line, and both literatures don't have the idea of the pseudo-coaxial line.

Therefore, assuming the configuration with a multilayer board, it is necessary to consider the structure of a new dual-polarized dipole antenna, including a balun circuit.

Therefore, an object of the present invention is to realize a dipole antenna, a dual-polarized antenna, and an array antenna that are suitable for the configuration of multilayer substrates and other three-dimensional circuits (LTCC, etc.) in the 28 GHz band and higher frequency bands.

Another object of the present invention is to realize a dipole antenna, a dual-polarized antenna, and an array antenna with a multi-layer substrate or a three-dimensional circuit configuration based thereon.

In addition, it is an object of the present invention to provide a dipole antenna, a dual polarized antenna, and an array antenna, having a wider band and better isolation and cross-polarization characteristics than patch antennas at frequencies above the 28 GHz band allocated by 5G, resulting in better MIMO performance and beamforming performance.

### Means for Solving the Problems

A dipole antenna in one embodiment of the present invention has,
an antenna unit provided on a dielectric layer; and
a pseudo-coaxial line formed on the dielectric layer and connected to the antenna unit, and
the pseudo-coaxial line comprises an outer conductor and a signal line.

A dipole antenna in one embodiment of the present invention is the dipole antenna mentioned above, wherein each of the outer conductor and the signal line is formed as a through hole.

The dipole antenna in one embodiment of the present invention is the dipole antenna mentioned above, wherein the signal line is arranged and surrounded by three or more of the outer conductors.

A dipole antenna in one embodiment of the present invention is the dipole antenna mentioned above, wherein
the signal line is arranged through the gap between the two antenna elements of the antenna unit,
the signal line is configured to excite the antenna unit,
the signal line faces one of the antenna elements at a predetermined distance, and
the signal line is connected to the other antenna element, and
the other antenna element is grounded by the pseudo-coaxial line.

A dipole antenna in one embodiment of the present invention is the dipole antenna mentioned above, wherein
the signal line is arranged through the gap between the two antenna elements of the antenna unit, and the signal line is configured to excite the antenna unit, and,
the signal line facing the two antenna elements of the antenna unit with predetermined distances therebetween, and the end opposite to the side to which the high frequency current or the high frequency current is supplied is open.

A dipole antenna in one embodiment of the present invention is the dipole antenna mentioned above, wherein
the dielectric layer comprises a first dielectric layer and a second dielectric layer,
the antenna unit is provided on the second dielectric layer, and
at least part of the signal line is provided on the first dielectric layer and forms a gap line.

A dipole antenna in one embodiment of the present invention is the dipole antenna mentioned above, wherein
a transmission layer having a transmission line is provided on the side of the dielectric layer opposite to the side on which the antenna unit is provided.

A dual polarized antenna in one embodiment of the present invention is the dual polarized antenna comprising two dipole antennas mentioned above, and the two dipole antennas are orthogonal to each other.

A dual polarized antenna in one embodiment of the present invention is the dual polarized antenna mentioned above, wherein the two dipole antennas are formed on different dielectric layers.

An array antenna in one embodiment of the present invention is the array antenna having a dividing circuit or a combining circuit, and a plurality of dipole antennas mentioned above, or a plurality of dual polarized antennas mentioned above.

With the above configuration, wideband electrical characteristics due to the dipole antenna are obtained in the present invention.

In addition, compared to conventional patch antennas, better cross-polarization discrimination characteristics and isolation characteristics are obtained, making it more suitable for polarized MIMO and beamforming.

### BRIEF DESCRIPTION OF THE DRAWINGS

FIG. 1 shows a configuration example of a dipole antenna in one embodiment of the present invention.

FIG. 2 shows a configuration example of a pseudo-coaxial line in one embodiment of the present invention.

FIG. 3 shows a configuration example of a dipole antenna in one embodiment of the present invention.

FIG. 4 shows a configuration example of a pseudo-coaxial line in one embodiment of the present invention.

FIG. 5 shows a configuration example of a pseudo-coaxial line in one embodiment of the present invention.

FIG. 6 shows a configuration example of a dipole antenna in one embodiment of the present invention.

FIG. 7 shows a configuration example of a dipole antenna in one embodiment of the present invention.

FIG. 8 shows a configuration example of a dipole antenna in one embodiment of the present invention.

FIG. 9 shows a configuration example of a dipole antenna in one embodiment of the present invention.

FIG. 10 shows a configuration example of a dipole antenna in one embodiment of the present invention.

FIG. 11 shows a configuration example of a dipole antenna in one embodiment of the present invention.

FIG. 12 shows a configuration example of a dipole antenna in one embodiment of the present invention.

FIG. 13 shows a configuration example of a dipole antenna in one embodiment of the present invention.

FIG. 14 shows a configuration example of a dipole antenna in one embodiment of the present invention.

FIG. 15 shows a configuration example of a dual-polarized antenna according to an embodiment of the present invention.

FIG. 16 shows a configuration example of a dual-polarized antenna according to an embodiment of the present invention.

FIG. 17 shows a configuration example of a dual-polarized antenna according to an embodiment of the present invention.

FIG. 18 shows a configuration example of an antenna array according to an embodiment of the present invention.

FIG. 19 shows a configuration example of an antenna array according to an embodiment of the present invention.

### DETAILED DESCRIPTION

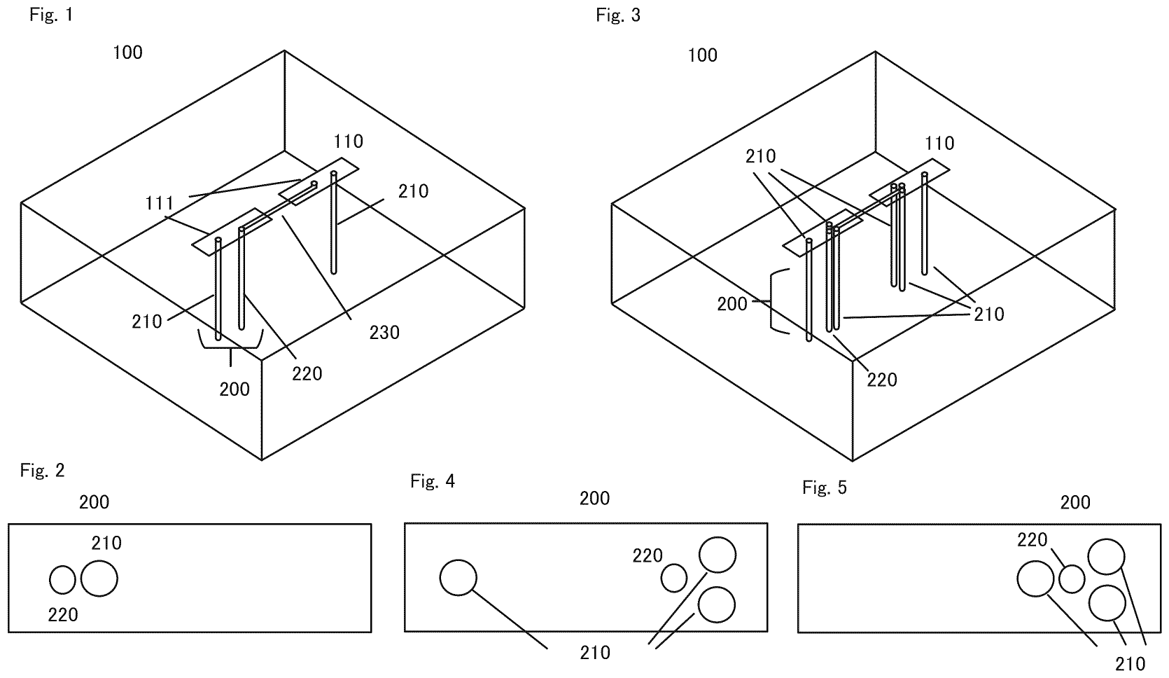

FIG. 1 shows a configuration example of a dipole antenna 100 according to one embodiment of the present invention.

The dipole antenna 100 has an antenna unit 110 provided on the dielectric layer 300.

A pseudo-coaxial line 200 is formed on the dielectric layer 300 and connected to the antenna unit 110. It should be noted that the pseudo-coaxial line connected to the antenna unit and “pseudo coaxial line” “connected to the antenna unit” designate that the outer conductor 210 is connected and it is not necessarily electrically connected to the antenna unit 110. In addition, the phrases “pseudo coaxial line connected to the antenna unit” and “pseudo coaxial line connected to the antenna unit” designate that the pseudo-coaxial line having the outer conductor and the signal line is connected to the same antenna element.

This embodiment has a short balun configuration, which will be described later.

FIG. 2 shows a configuration example of a pseudo-coaxial circuit in one embodiment of the present invention.

The pseudo coaxial line 200 has an outer conductor 210 and a signal line 220.

In this embodiment, the outer conductor 210 and the signal line 220 are configured by through holes.

This configuration facilitates formation of the outer conductor 210 and the signal line 220.

In one embodiment, the frequency of radio waves transmitted or received by the dipole antenna 100 is 28 GHz or higher. It may be implemented at 24.7 GHz to GHz, and may be 24.7 GHz or higher.

With this configuration, it is also compatible with the 5G standard.

FIG. 3 shows a configuration example of the dipole antenna 100 in one embodiment of the present invention. Also, FIG. 4 shows a configuration example of the pseudo coaxial line 200 in one embodiment of the present invention.

In this embodiment, three or more pseudo coaxial lines 200 are connected to the antenna unit 110.

The signal line 220 is arranged surrounded by three or more outer conductors 210. “arranged and surrounded by the outer conductors 210” designates that, in a cross section, half or more of the vertically extending portion of the signal line 220 is arranged in a plane connecting three or more surrounding outer conductors 210. Therefore, in addition to the configuration shown in FIG. 4, the configuration example of the pseudo coaxial line 200 shown in FIG. 5 may be used.

With this configuration, both the influence from the signal line 220 and the influence on the signal line 220 can be suppressed by the outer conductor 210, and the influence from the outside, the influence to the outside, the degree of cross polarization discrimination, and the isolation characteristics are improved. That is, by adopting the structure of the pseudo coaxial line 200, the characteristics of the antenna can be improved.

As shown in FIGS. 3 and 4, the dipole antenna 100 may have an axis of symmetry in the center in the vertical direction, and the outer conductor 210 and the signal line 220 may also be arranged symmetrically about the axis of symmetry. In this case, the aforementioned characteristics and the like are further improved. The same applies to the configuration shown in FIG. 5.

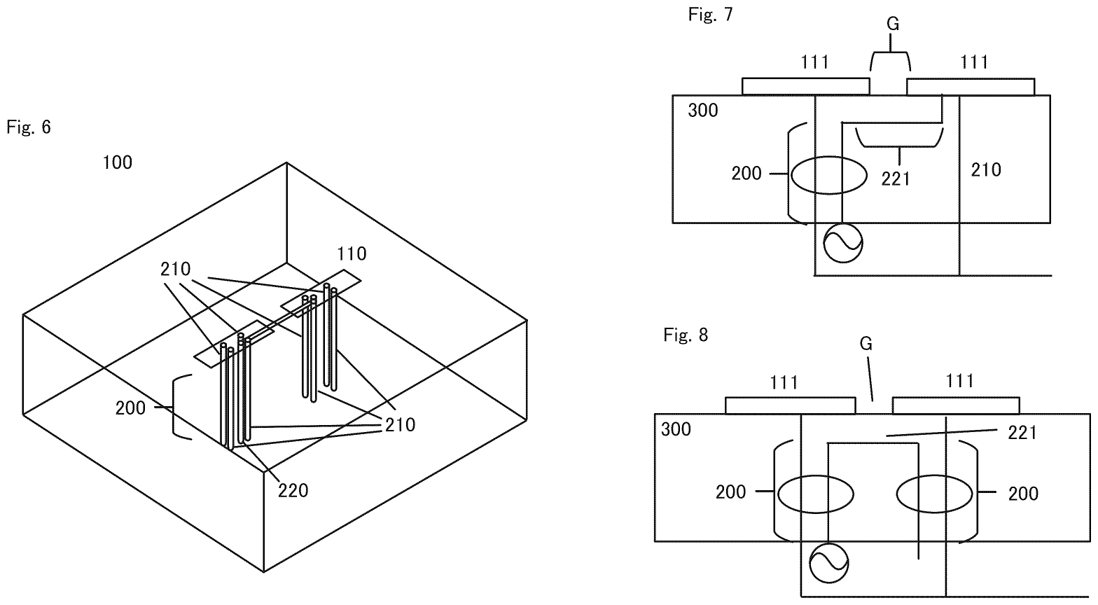

FIG. 6 shows a configuration example of the dipole antenna 100 in one embodiment of the present invention. In this embodiment, four outer conductors 210 surround one signal line 220.

The number of outer conductors 210 surrounding the signal line 220 may be five or more.

A plurality of signal lines 220 may be connected to one dipole element. With this configuration, accuracy can be improved in controlling the dipole antenna 100.

Also, one outer conductor 210 may belong to a plurality of pseudo coaxial lines 200 in terms of structure. With this configuration, it is possible to efficiently suppress the influence between the signal lines 220 with a small number of the outer conductors 210.

FIG. 7 schematically shows a circuit configuration example of the dipole antenna 100 in one embodiment of the present invention.

A high frequency voltage or high frequency current is supplied to the signal line 220.

The signal line 220 is arranged through the gap G between the two antenna elements 111 of the antenna unit 110 and excites the antenna unit 110.

The signal line 220 faces one of the two antenna elements 111 of the antenna unit 110 at a predetermined distance from the lower side of the antenna element 111, passes through the gap to be connected to the other antenna element 111, and the other antenna element 111 is grounded by a pseudo coaxial circuit, to be configured as the short balun structure. The signal line 220 is preferably connected to the antenna unit 110 at the end of the antenna element 111.

Here, “grounded” designates not only being directly grounded, but also being connected to a grounding terminal or conducting wire, or being connected to a grounding terminal or a terminal to be connected to a conducting wire, etc.

In this embodiment, a return loss of −10 dB or less is obtained at 24.7 to 30.2 GHz.

FIG. 8 schematically shows a circuit configuration example of the dipole antenna 100 in one embodiment of the present invention.

A high frequency voltage or high frequency current is supplied to the signal line 220.

The signal line 220 is arranged through the gap G between the two antenna elements 111 of the antenna unit 110 and excites the antenna unit 110.

The signal line 220 is opposed to the two antenna elements 111 of the antenna unit 110 with predetermined distances from the lower side of the antenna element 111, and the end opposite to the side to which the high-frequency current or the high-frequency current is supplied is open without being electrically connected to other circuits, such that an open balun configuration is configured.

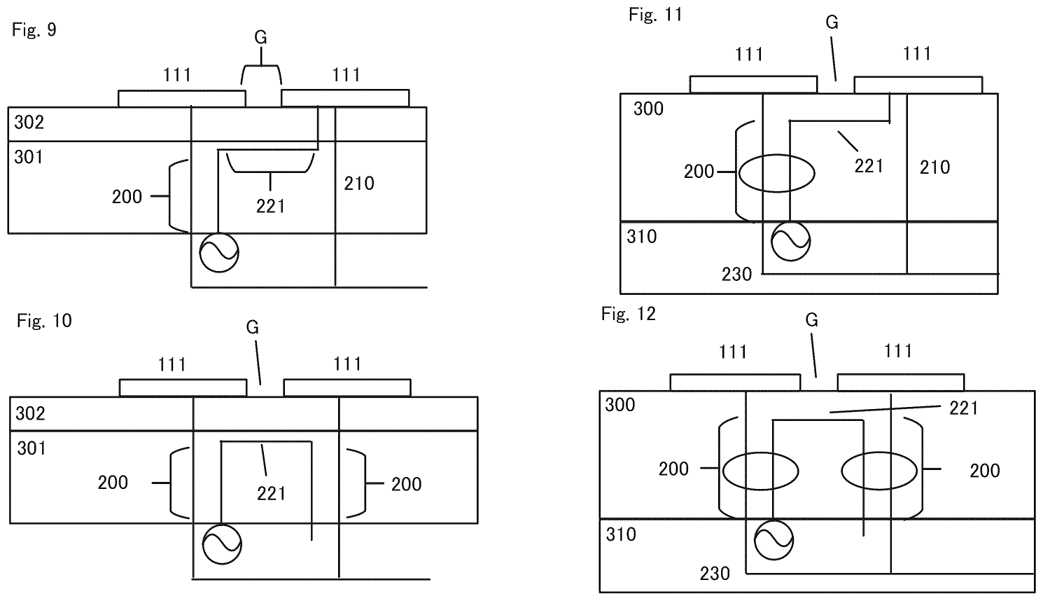

FIGS. 9 and 10 schematically show a configuration example of the dipole antenna 100.

FIG. 9 shows a short balun configuration, and FIG. 10 shows an open balun configuration.

The dielectric layer 300 has a first dielectric layer 301 and a second dielectric layer 302.

An antenna unit 110 is provided on the second dielectric layer 302.

In addition to that, at least part of the signal line 220 is provided on the first dielectric layer 301 to form a gap line 221. The gap line 221 supplies a necessary potential to the antenna unit 110 by arranging the signal line 220 with a predetermined distance from the antenna unit 110.

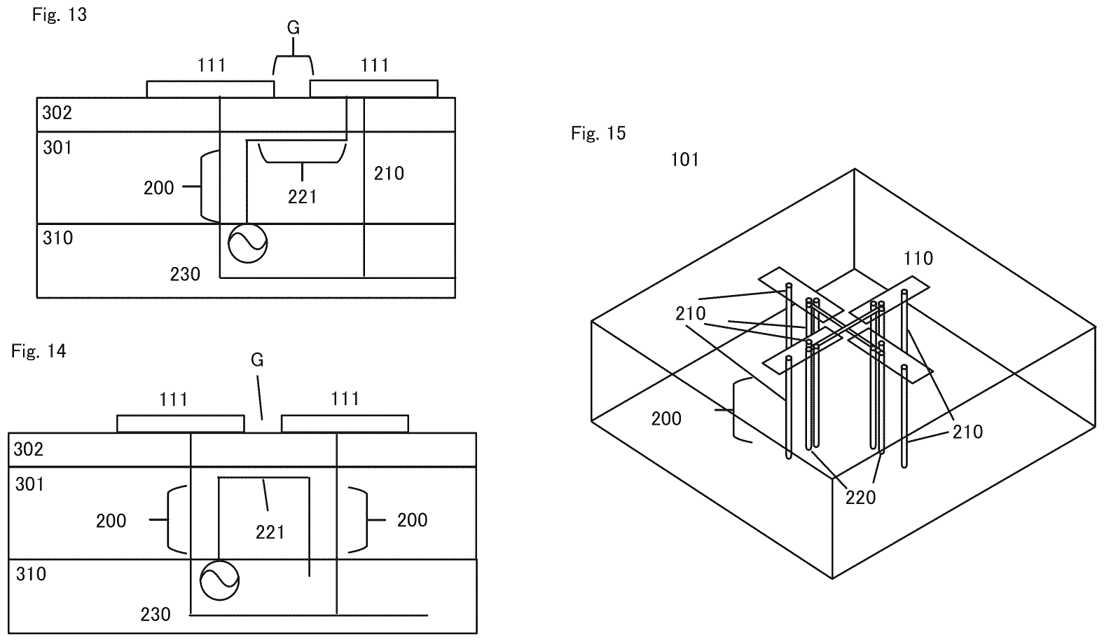

FIGS. 11 and 12 schematically show a configuration example of the dipole antenna 100.

FIG. 11 shows a short balun configuration, and FIG. 12 shows an open balun configuration.

In this embodiment, a transmission layer 310 having a transmission line 230 is provided on the side of the dielectric layer 300 opposite to the side on which the antenna unit 110 is provided. In the transmission layer 310, the circuitry required for the antenna can be constructed.

A short balun configuration having a second dielectric layer as shown in FIG. 13 or an open balun configuration having a second dielectric layer as shown in FIG. 14 may be used.

FIG. 15 schematically shows a configuration example of the dual polarized antenna 101 in one embodiment of the present invention.

The dual polarized antenna 101 has two dipole antennas 100 described above, and the two dipole antennas 100 are orthogonal to each other.

In this configuration in which three or more pseudo coaxial lines 200 are provided, the degree of cross-polarization discrimination and the isolation characteristics between the two antenna units 110 are particularly improved, with a return loss of −10 dB at 24.7 GHz to 30.2 GHz and around 25 dB of isolation characteristics can be obtained.

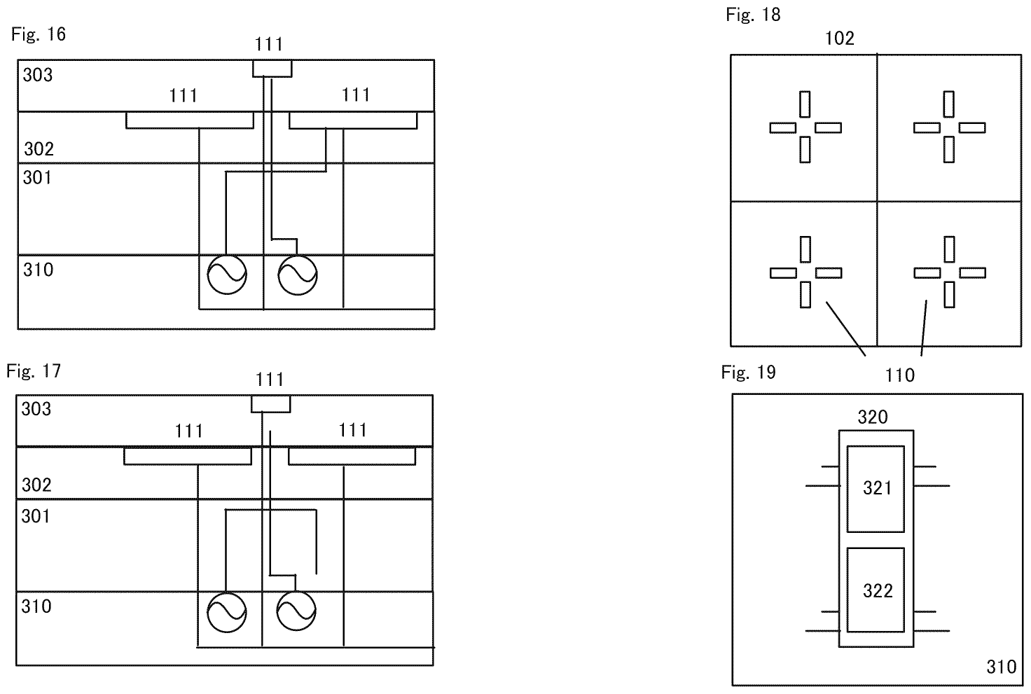

FIGS. 16 and 17 schematically show a configuration example of the dual polarized antenna 101 in one embodiment of the present invention.

FIG. 16 shows a short balun configuration, and FIG. 17 shows an open balun configuration.

A second dielectric layer 302 is formed on the first dielectric layer 301, and a third dielectric layer 303 is formed on the second dielectric layer 302.

The two dipole antennas 100 are formed on different dielectric layers 300. That is, one dipole antenna 100 is formed on the second dielectric layer 302 and another dipole antenna 100 orthogonal to this dipole antenna 100 is formed on the third dielectric layer 303.

A plurality of dipole antennas 100 can be formed on the second dielectric layer 302 and the third dielectric layer 303 in a case where enough space is provided.

With this configuration, two or more dipole antennas 100 can be easily designed and formed according to the installation area, characteristics, and the like.

FIG. 18 shows a configuration example of the array antenna 102 in one embodiment of the present invention.

As shown in FIG. 19, the array antenna 102 has a distribution circuit 321 or a combining circuit 322. It also has a plurality of the above-described dual polarized antennas 101.

In this embodiment, the dividing and combining unit 320 has a dividing circuit 321 and a combining circuit 322, and the dividing circuit 321 and the combining circuit 322 are connected to a plurality of dual polarized antennas 101.

The array antenna 102 can also be configured to have a plurality of the dipole antennas 100 described above.

With the configuration described above, it is possible to obtain wideband electrical characteristics due to the dipole antenna, and to obtain better cross-polarization discrimination characteristics and isolation characteristics than conventional patch antennas, such that it is very advantageous in MIMO and beam forming.

In particular, it is easy to route lines of the power supply circuit, since a multi-layer board can be used.

In addition, compared to patch antennas, cross-polarized waves are less and MIMO effects are enhanced, and the directivity of the element can be flexibly changed, such as by widening or narrowing the beam width or lowering the side lobes, resulting in greater design freedom. is high.

It goes without saying that the present invention is not limited to the above-described embodiments and includes various embodiments without departing from the spirit and scope of the present invention.

### EXPLANATION OF REFERENCE NUMERALS

100 Dipole antenna
101 Polarized antenna
102 Array antenna
110 Antenna unit
111 Antenna element
200 Pseudo coaxial line
210 Outer conductor
220 Signal line
221 Gap line
230 Transmission line
300 Dielectric layer
301 First dielectric layer
302 Second dielectric layer
303 Third dielectric layer
310 Transmission layer
320 Dividing and combining unit
321 Distribution circuit
322 Synthesis circuit
G Gap

1: A dipole antenna comprising:
an antenna unit provided on a dielectric layer; and
a pseudo coaxial line formed on the dielectric layer and connected to the antenna unit, and
the pseudo coaxial line comprises an outer conductor and a signal line.

2: The dipole antenna according to claim 1, wherein
each of the outer conductor and the signal line is formed as a through hole.

3: The dipole antenna according to claim 1, wherein
the signal line is arranged and surrounded by three or more of the outer conductors.

4: The dipole antenna according to claim 1, wherein
the signal line is arranged through the gap between the two antenna elements of the antenna unit,
the signal line is configured to excite the antenna unit,
the signal line faces one of the antenna elements at a predetermined distance, and
the signal line is connected to the other antenna element, and
the other antenna element is grounded by the pseudo-coaxial line.

5: The dipole antenna according to claim 1, wherein
the signal line is arranged through the gap between the two antenna elements of the antenna unit, and the signal line is configured to excite the antenna unit, and,
the signal line facing the two antenna elements of the antenna unit with predetermined distances therebetween, and the end opposite to the side to which the high frequency current or the high frequency current is supplied is open.

6: The dipole antenna according to claim 1, wherein
the dielectric layer comprises a first dielectric layer and a second dielectric layer,
the antenna unit is provided on the second dielectric layer, and
at least part of the signal line is provided on the first dielectric layer and forms a gap line.

7: The dipole antenna according to claim 1, wherein a transmission layer having a transmission line is provided on the side of the dielectric layer opposite to the side on which the antenna unit is provided.

8: A dual polarized antenna comprising two dipole antennas according to claim 1, wherein the two dipole antennas are orthogonal to each other.

9: The dual polarized antenna according to claim 8, wherein the two dipole antennas are formed on different dielectric layers.

10: An array antenna comprising;
a dividing circuit or a combining circuit, and
a plurality of dipole antennas according to claim 1, or a plurality of dual polarized antennas according to claim 8.

11: An array antenna comprising;
a dividing circuit or a combining circuit, and
a plurality of dual polarized antennas comprising two dipole antennas according to claim 1, wherein the two dipole antennas are orthogonal to each other.
